(19) United States
(12) Patent Application Publication
(10) Pub. No.: US 2005/0223203 A1
(43) Pub. Date: Oct. 6, 2005

(54) Segmented branch predictor

(76) Inventor: Gabriel Loh, Austin, TX (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/815,241

(22) Filed: Mar. 30, 2004

(51) Int. Cl. G06F 9/00

(52) U.S. Cl. 712/239

(57) ABSTRACT

A branch prediction technique involving segmented branch history information, intermediate branch predictors, and a final branch prediction. More particularly, embodiments of the invention relate to segmenting a branch prediction into an intermediate prediction and a final prediction, which uses the intermediate prediction to generate a final branch prediction.

### FIELD

Embodiments of the invention relate to microprocessor architecture. More particularly, embodiments of the invention relate to improving branch prediction accuracy while not significantly affecting branch prediction latency by a long segmented branch history register in conjunction with a final branch predictor to incorporate the results of a number of segmented branch history predictors.

### BACKGROUND

Although branch prediction accuracies within modern microprocessors are relatively high, increasing processor pipeline depths and larger in-flight instruction capacities continue to drive the need for better branch prediction techniques. Branch predictors also play an important role in a processor's power consumption, as the energy consumed by wrong-path instructions is wasted. Further complicating the problem are steadily decreasing clock cycle times, which leave a branch predictor with less time to perform its prediction.

Modern branch predictors must not only be highly accurate, but they must also have a latency that matches the performance needs of the processor in which they are used. Typical branch prediction techniques are based on branch correlation and make use of a history of the most recent branch outcomes to provide context in making predictions.

Although some branch predictors techniques make use of relatively short branch histories, higher prediction accuracies can be obtained by making use of longer branch histories. However, branch prediction techniques using long branch histories can suffer from longer branch prediction latency, especially as the branch history size is scaled.

FIG. 1a illustrates a prior art branch prediction technique in which a relatively long branch history is used. The branch prediction technique illustrated in FIG. 1 uses one branch prediction unit or multiple parallel branch prediction units to perform a branch prediction based off of all or some of the prediction history results in the prediction history register. The calculation of the branch history result can be computationally intensive, as it involves a relatively large number of branch history values.

Although prior art branch prediction techniques can provide adequate prediction accuracy, the hardware and/or software required to implement these long-history predictors can suffer from performance latencies, which can negate much of the performance benefit of using long histories for higher prediction accuracy.

### BRIEF DESCRIPTION OF THE DRAWINGS

Embodiments of the invention are illustrated by way of example and not limitation in the figures of the accompanying drawings, in which like references indicate similar elements and in which:

FIG. 1 is a prior art branch prediction technique using a relatively long record of branch history.

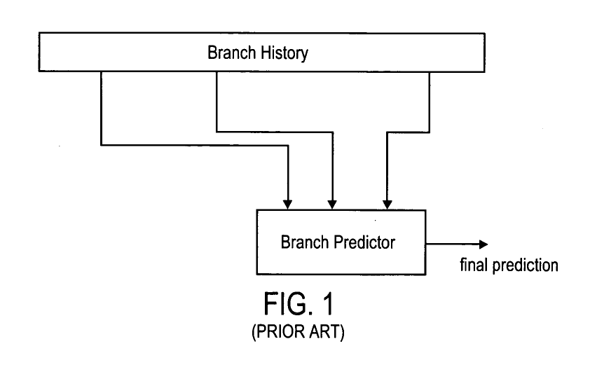

FIG. 2 illustrates a computer system that may be used in conjunction with at least one embodiment of the invention.

FIG. 3 illustrates a microprocessor architecture in which embodiments of the invention may be implemented.

FIG. 4 illustrates one embodiment of the invention, in which portions of prediction information are used to generate a number of intermediate predictions in parallel, which are then used to generate a final prediction.

FIG. 5 is a flow diagram illustrating a method for performing at least one embodiment of the invention.

### DETAILED DESCRIPTION

Embodiments of the invention relate to microprocessor architecture. More particularly, embodiments of the invention relate to segmenting a branch prediction into an intermediate prediction and a final prediction, which uses the intermediate prediction to generate a final branch prediction.

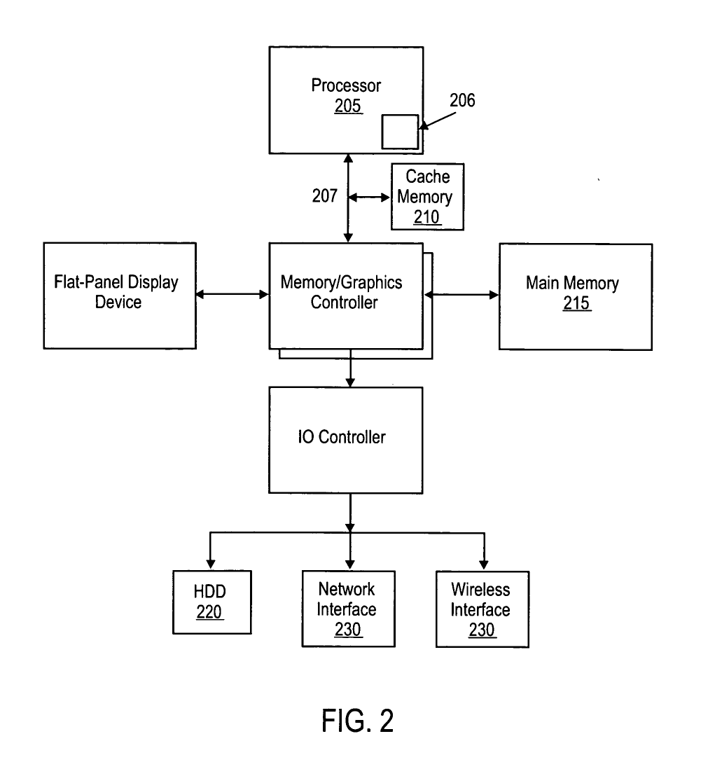

FIG. 2 illustrates a computer system that may be used in conjunction with at least one embodiment of the invention. A processor 205 accesses data from a cache memory 210 and main memory 215. Illustrated within the processor of FIG. 2 is the location of one embodiment of the invention 206. However, embodiments of the invention may be implemented within other devices within the system, as a separate bus agent, or distributed throughout the system. The main memory may be dynamic random-access memory (DRAM), a hard disk drive (HDD) 220, or a memory source 230 located remotely from the computer system containing various storage devices and technologies. The cache memory may be located either within the processor or in close proximity to the processor, such as on the processor's local bus 207. Furthermore, the cache memory may be composed of relatively fast memory cells, such as six-transistor (6T) cells, or other memory cells of approximately equal or faster access speed.

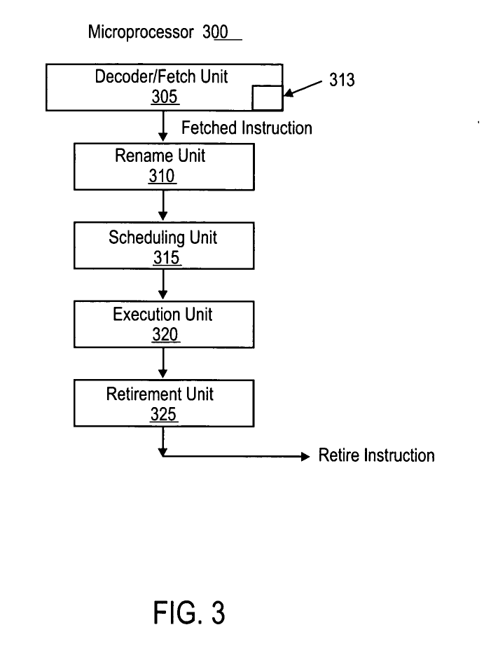

FIG. 3 illustrates a microprocessor architecture in which embodiments of the invention may be implemented. The processor 300 of FIG. 3 comprises an execution unit 320, a scheduling unit 315, rename unit 310, retirement unit 325, and decoder unit 305.

In one embodiment of the invention, the microprocessor is a pipelined, super-scalar processor that may contain multiple stages of processing functionality. Accordingly, multiple instructions may be processed concurrently within the processor, each at a different pipeline stage. In other embodiments, the execution unit may be a single execution unit.

At least one embodiment 313 of the invention resides within the instruction fetch unit. However, other embodiments of the invention may reside in other functional units of the processor or within several functional units of the processor.

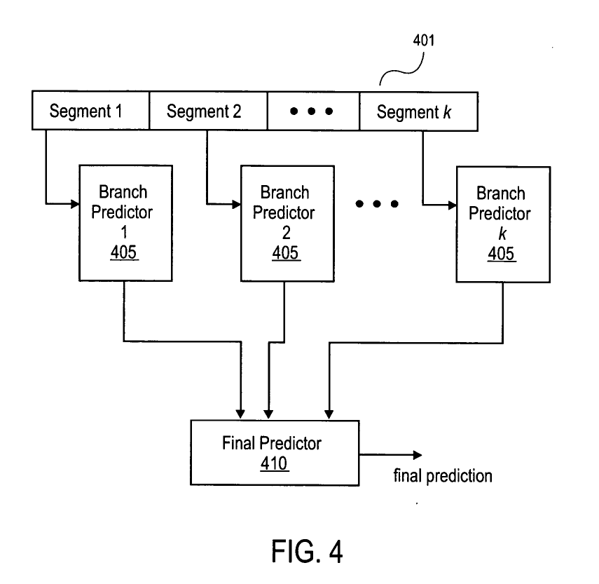

FIG. 4 illustrates one embodiment of the invention, in which portions of prediction information are used to generate a number of intermediate predictions in parallel, which are then used to generate a final prediction. More specifically, FIG. 4 illustrates a prediction history register 401, in which prediction history is stored in one emodiment of the invention. The prediction history register may also be a memory location instead of a register within the processor or some combination thereof. The prediction history information may be accessed in segments by a number of intermediate branch prediction units 405.

In one embodiment of the invention, four intermediate branch history units access four segments of branch history from the branch history register. However, in other embodiments, the number of segments and corresponding intermediate branch history units may be greater or fewer than four. In some embodiments of the invention, some intermediate branch history units may be in parallel and others may be in series with any of the parallel branch history units. Furthermore, the series intermediate branch history units may perform intermediate branch predictions in parallel with each other in other embodiments of the invention.

The number of branch history segments may not be equal to the number of intermediate branch history predictors in other embodiments of the invention. Also illustrated in FIG. 4 is a final branch history predictor unit 410 to generate a final branch prediction as function of the intermediate branch predictions performed by the intermediate branch prediction units.

In at least one embodiment of the invention, the branch history information stored within the branch history register is of a particular type, such as global history, which reflects prior branch predictions or results of prior branch predictions for a various branches in a program, or local history, which reflects results of prior branch predictions corresponding to a particular branch in a program. Furthermore, in other embodiments of the invention, the branch history register may contain a combination of various branch history information.

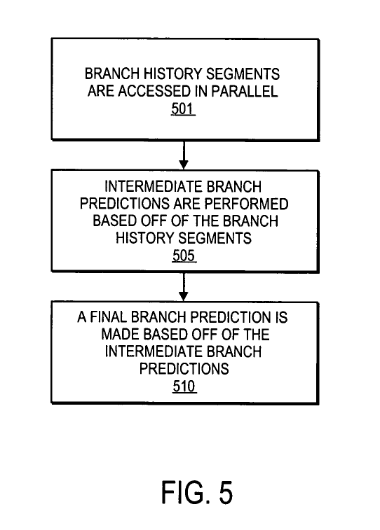

FIG. 5 is a flow diagram illustrating a method for performing at least one embodiment of the invention. In operation 501, a number of branch prediction segments are accessed in parallel. At operation 505, a number of intermediate branch predictions are performed based off of the branch prediction segments, in which each intermediate branch prediction is based off of a different branch history segment and each branch history segment is smaller than the sum of the branch history segments. At operation 510, a final branch prediction is made based off of the intermediate branch predictions.

Embodiments of the invention may be implemented using complimentary metal-oxide-semiconductor (CMOS) circuits (hardware). Furthermore, embodiments of the invention may be implemented by executing machine-readable instructions stored on a machine-readable medium (software). Alternatively, embodiments of the invention may be implemented using a combination of hardware and software.

While the invention has been described with reference to illustrative embodiments, this description is not intended to be construed in a limiting sense. Various modifications of the illustrative embodiments, as well as other embodiments, which are apparent to persons skilled in the art to which the invention pertains are deemed to lie within the spirit and scope of the invention.

1. An apparatus comprising:
storage means for storing a first type of branch history information;
intermediate prediction means for generating a plurality of intermediate branch prediction results based off of a plurality of portions of the store branch history information, wherein the intermediate prediction means uses a portion of the branch history information that is smaller than all of the branch history information stored within the storage means in order to generate the plurality of intermediate branch prediction results;
final prediction means for generating a final branch prediction result based off of the plurality of intermediate branch prediction results.

2. The apparatus of claim 1 wherein the storage means is a register within a microprocessor.

3. The apparatus of claim 1 wherein the storage means is a memory location within a computer system.

4. The apparatus of claim 1 wherein the intermediate prediction means comprises a plurality of intermediate branch predictors to perform a plurality of intermediate branch predictions in parallel.

5. The apparatus of claim 1 wherein the final prediction means is a single branch predictor.

6. The apparatus of claim 1 wherein the intermediate branch prediction means comprises a first plurality of intermediate branch prediction units to perform a plurality of branch predictions in parallel, and a second plurality of intermediate branch prediction units to perform a plurality of branch predictions in series with the first plurality of intermediate branch prediction units.

7. A computer system comprising:
a memory unit to store a first and second plurality of instructions;
a processor to predict whether to execute the first or the second plurality of instructions based, at least in part, on an intermediate branch prediction to be made by a plurality of intermediate branch prediction units, the intermediate branch history units each corresponding to a different portion of a set of branch history information, each different portion being smaller than the set of branch history information.

8. The computer system of claim 7 wherein the processor comprises a final branch prediction unit to perform a final branch prediction based on predictions of the intermediate branch prediction units.

9. The computer system of claim 8 further comprising a branch history storage unit to store the set of branch history information.

10. The computer system of claim 9 wherein the branch history storage unit is a memory location.

11. The computer system of claim 9 wherein the branch history storage unit is a register within the processor.

12. A processor comprising:
a storage unit for storing a first type of branch history information;
a plurality of intermediate prediction units to generate a plurality of intermediate branch prediction results based off of a plurality of portions of the store branch history information, wherein each intermediate prediction unit uses a portion of the branch history information that is smaller than all of the branch history information stored within the storage unit in order to generate the plurality of intermediate branch prediction results.

13. The processor of claim 12 further comprising a final prediction unit to generate a final branch prediction result based off of the plurality of intermediate branch prediction results.

14. The processor of claim 13 wherein the storage unit is a register within a microprocessor.

15. The processor of claim 13 wherein the storage unit is a memory location within a computer system.

16. The processor of claim 13 wherein the intermediate prediction units are to perform a plurality of intermediate branch predictions in parallel.

17. The processor of claim 13 wherein the intermediate branch prediction units comprise a first plurality of intermediate branch prediction units to perform a plurality of branch predictions in parallel, and a second plurality of intermediate branch prediction units to perform a plurality of branch predictions in series with the first plurality of intermediate branch prediction units.

18. A method comprising:
accessing a plurality of branch prediction segments in parallel;
performing a plurality of intermediate branch predictions based off of the plurality of branch prediction segments, wherein each intermediate branch prediction is based off of a different branch prediction segment and each branch prediction segment is smaller than the sum of the branch prediction segments.

19. The method of claim 18 further comprising performing a final branch prediction based off of the plurality of intermediate branch predictions.

20. A machine-readable medium comprising instructions, which if executed by a machine, cause the machine to perform a method comprising:
accessing a plurality of branch prediction segments in parallel;
performing a plurality of intermediate branch predictions based off of the plurality of branch prediction segments, wherein each intermediate branch prediction is based off of a different branch prediction segment and each branch prediction segment is smaller than the sum of the branch prediction segments.

21. The machine-readable medium of claim 20 further comprising performing a final branch prediction based off of the plurality of intermediate branch predictions.
